(19) United States
(12) Patent Application Publication
(10) Pub. No.: US 2015/0332552 A1
(43) Pub. Date: Nov. 19, 2015

(54) INDIVIDUALIZED INTERACTIVE TABLE GAMING MACHINE

(71) Applicant: Novel Tech International Limited, Hong Kong (HK)

(72) Inventor: Jay Chun, Hong Kong (HK)

(21) Appl. No.: 14/508,922

(22) Filed: Oct. 7, 2014

Related U.S. Application Data
(60) Provisional application No. 62/000,523, filed on May 19, 2014.

(51) Int. Cl. G07F 17/32

(52) U.S. Cl. CPC G07F 17/3244; G07F 17/3211

(57) ABSTRACT

An individualized interactive table gaming machine includes input component(s) that accept a physical activation from a user for wager based game play, a processor coupled to the input component(s) and adapted to facilitate game play, display component(s) coupled to the processor and adapted to display game play information, and a physical randomizing component dedicated to that individual machine that can have one or more physical objects from table type games that provide substantially random outcomes when actuated by the processor. The substantially random outcomes provide game results, and actuation by the processor results from the physical activation from the user, wherein variations in the physical activation can affect variations to the substantially random outcomes of the one or more physical objects. Machines can be linked to other machines and/or a system server to facilitate cross-wagering, searching, tournament play, and other activities.

### NOTICE OF RELATED APPLICATION

This application claims priority from co-pending and commonly owned U.S. Provisional Patent Application No. 62/000,523, entitled “INDIVIDUALIZED INTERACTIVE TABLE GAMING MACHINE,” filed May 19, 2014, which application is incorporated herein in its entirety and for all purposes.

### TECHNICAL FIELD

The present invention relates generally to gaming machines, tables and systems, and more particularly to gaming machines having automated components.

### BACKGROUND

Wagering games such as baccarat, blackjack, roulette, craps, sic-bo, and various poker-based table games, among many others, are popular table games offered in casinos and other similar establishments. These table games are typically administered by human dealers and are played on physical gaming tables having a dealer surface, felt or similar table top layouts, cards, dice, chips and the like. Alternatively, such table games can be played on electronic gaming machines where the dealer, playing cards, chips or other gaming elements may be virtual.

Other wagering games can also be played on electronic gaming machines, which have become increasingly popular over the years. Such gaming machines generally include slot machine or “slots” type games, as well as video poker, video keno, video blackjack, and the like. Many players like the anonymity and individualized nature of playing such machines alone or away from the crowds that are often attracted to table type games. One feature that is very common for such electronic gaming machines is the use of a processor based random number generator (“RNG”), the implementation of which is often necessary for such gaming machines to be able to offer huge jackpots that are appealing to players. The ability to have software controlled RNG also allows for fully automated gaming in a relatively secure and fully functional environment without the need for manual operator oversight.

Unfortunately, the use of RNG type processors and pseudo RNG machines involve significant regulatory oversight and thus added expenses. In addition, some players can be turned off by the notion that their odds of winning RNG type games can be very small compared to their odds of winning other live games, such as table type games. Further, some players also may not trust a “machine” (such as a software controlled RNG type machine) to be accurate or fair when it comes to determining a randomized result to a wagering game, and thus may not be as inclined to play such machines. This can result in situations where players would like to play table type games or other games where results are randomly generated by physical means and not software, but do not wish to be involved in crowds or even with other people in some instances. Although some electronic gaming machines do offer table type games, these are typically provided with an RNG or other similar “artificial” virtual element to them that distracts from the live action that is provided by a real table game.

While gaming machines, gaming tables, and systems therefor have worked well in practice over many years, there is always a desire for improvement. In particular, what is desired are improved gaming machines that are able to provide more realistic live table game elements to players who might prefer to play at an individual electronic gaming machine or device.

### SUMMARY

It is an advantage of the present disclosure to provide electronic gaming machines that facilitate more realistic live table game play for players in an individual setting. This can be accomplished at least in part through the use of self-contained individualized interactive table gaming machines that include a dedicated processor and other electronic components, as well as a dedicated mechanical or physical randomizing component that includes one or more physical game objects from actual table type games. The actual physical game object or objects can provide substantially random outcomes that form at least a part of actual game results upon which the player at the self-contained gaming machine places wagers to win or lose.

In various embodiments of the present disclosure, an individualized interactive table gaming machine can include one or more input components, a processor coupled thereto, one or more display components coupled to the processor, and a physical randomizing component coupled to the processor. The one or more input components can be adapted to accept a physical activation from a single player or “user” regarding the play by the single user of wager based games that involve the placement of wagers by the single user, the play of games by the single user based upon the wagers, and the grant of monetary awards to the single user based upon game results. The processor can be adapted to facilitate the administration and play of wager based games, such as by accepting input from the input component(s) and utilizing the input to facilitate the play of the wager based games, providing information to the display component(s), and providing actuation to and receiving results from the physical randomizing component. The one or more display components can be adapted to display to the user information regarding the wager based games played by the user. Also, the physical randomizing component can include one or more physical game objects from table type games that provide substantially random outcomes when actuated by the processor. The substantially random outcomes of the one or more physical game objects can form at least a part of the game results, wherein actuation by the processor results from the physical activation from the user or player. Variations in the physical activation from the user can affect variations to the substantially random outcomes of the one or more physical game objects.

In various detailed embodiments, neither said processor nor any other associated processing component provides an electronic random number generated output for use by the gaming machine. The game results can be based completely upon the substantially random outcomes of the one or more physical game objects. In some embodiments, the one or more physical game objects can be one or more physical dice, one or more physical playing cards, one or more physical balls, one or more physical wheels, or any combination thereof. In various embodiments, variations in the physical activation from the single user can result in weaker or stronger actuation of the one or more physical game objects. The variations in the physical activation from the single user can include a weaker or stronger physical activation, and/or can include the timing of the physical activation. In some embodiments, the substantially random outcomes of the one or more physical game objects provide results for a bonus game outcome.

In some detailed embodiments, one or more sensor components can also be included, with such sensor component(s) being adapted to detect the substantially random outcomes of the one or more physical game objects. In such embodiments, the sensor components can be coupled to the processor and adapted to communicate the detected physical game object outcomes to the processor, with the processor being further adapted to use the communicated physical game object outcomes to process the game results for the user. In various embodiments, the gaming machine is fully self-contained and thereby adapted to facilitate the processing of all game aspects without any need for further input from any other system components or any manual operator intervention.

In various embodiments, the gaming machine can also include a network interface coupled to the processor and adapted to couple the gaming machine to one or more outside networked devices, said one or more outside networked devices including one or more substantially similar gaming machines, a network server, or both. In such “remote wagering” embodiments, the gaming machine can further provide the user with the ability to wager on substantially random outcomes of one or more physical game objects located at another networked substantially similar gaming machine. In addition, the gaming machine can further provide the user with the ability to search past results from substantially random outcomes of one or more physical game objects located at one or more other networked substantially similar gaming machines. Also, the gaming machine can further provide the user with the ability to participate in a tournament based upon substantially random outcomes of one or more physical game objects located at one or more other networked substantially similar gaming machines.

In various further embodiments, an interactive table gaming machine system can include a plurality of self-contained individualized interactive table gaming machines, wherein each of said gaming machines can include some or all of the foregoing items and features set forth above, and in any combination, as may be desired. Again, a network interface can be adapted to couple each gaming machine to one or more system devices including one or more others from the plurality of self-contained individualized interactive table gaming machines, a network server, or both. In addition, the system can include a network server coupled to one or more of the plurality of self-contained individualized interactive table gaming machines, said network server being adapted to facilitate interactivity between the plurality of self-contained individualized interactive table gaming machines. In such embodiments, the system can provide one or more players or users with the ability to wager, such as remotely, on substantially random outcomes of one or more physical game objects located at one or more of the self-contained individualized interactive table gaming machines that are separate from the one being used by the user. The system can also provide one or more users or players with the ability to search past results from substantially random outcomes of one or more physical objects located at one or more of the self-contained individualized interactive table gaming machines that are separate from the one being used by the user, and also the ability to participate in a tournament based upon substantially random outcomes of one or more physical game objects located at one or more of the self-contained individualized interactive table gaming machines that are separate from the one being used by the user.

Other apparatuses, methods, features and advantages of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed inventive apparatuses, systems and methods for individualized interactive table gaming machines and systems therefor. These drawings in no way limit any changes in form and detail that may be made to the disclosure by one skilled in the art without departing from the spirit and scope of the disclosure.

FIG. 1 illustrates in front perspective view an exemplary individualized interactive table gaming machine according to one embodiment of the present disclosure.

FIG. 2A illustrates in front elevation view an alternative exemplary individualized interactive table gaming machine according to one embodiment of the present disclosure.

FIGS. 2B-2D illustrate in front elevation close up views various portions of the alternative exemplary individualized interactive table gaming machine of FIG. 2A according to one embodiment of the present disclosure.

FIG. 3 illustrates in block diagram format an exemplary wide area interactive table gaming machine system utilizing multiple gaming machines, a system server, and various other system components across multiple locations according to one embodiment of the present disclosure.

FIG. 4 provides a flowchart of an exemplary method of administering a wager based game on an individualized or personalized table gaming machine according to one embodiment of the present disclosure.

### DETAILED DESCRIPTION

Exemplary applications of apparatuses and methods according to the present disclosure are described in this section. These examples are being provided solely to add context and aid in the understanding of the disclosure. It will thus be apparent to one skilled in the art that the present disclosure may be practiced without some or all of these specific details. In other instances, well known process steps have not been described in detail in order to avoid unnecessarily obscuring the present disclosure. Other applications are possible, such that the following examples should not be taken as limiting.

In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to devices, systems and methods for providing, conducting and facilitating the play of wagering games at personalized or individualized interactive electronic table gaming machines. Such gaming machines or devices provide for the actual use of live physical table game components in a self-contained and individualized manner, with such physical components including dice, cards, balls, wheels, and the like. As such, this disclosure may be applied to the individualized machine implementation of any live table game, such as baccarat, blackjack, roulette, craps, pai gow, sicbo, poker, bingo, keno, card games, and the like, as well as any other type of table game having physical components that result in game outcomes. The various embodiments disclosed herein can be applied with respect to individual gaming machines, entire systems involving multiple gaming machines, and methods of operating and tracking games on such machines and systems.

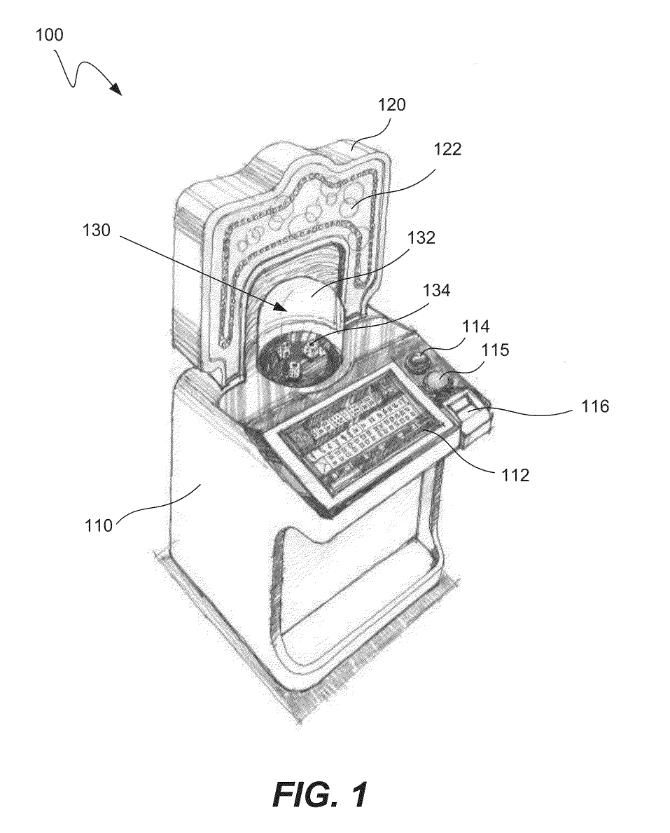

Referring first to FIG. 1, an exemplary individualized interactive table gaming machine according to one embodiment of the present disclosure is illustrated in front perspective view. It will be readily appreciated that this individualized interactive table gaming machine (“eMachine”) 100 can be provided in numerous other configurations and formats, such that the provided example is for illustrative purposes only. In various embodiments, eMachine 100 can be designed or configured similar to a standard “slot machine,” such that only one actual player sits at or otherwise occupies the machine, and is the only player that is permitted to make wagers and plays on the game outcomes at the device. Of course, other people may watch or comment as the one player plays at the eMachine 100 designed for individualized play. In some embodiments, other players might be allowed to make wagers on the game outcomes, such as where remote monitoring and play is permitted across a system of eMachines.

In general, eMachine 100 can include a base portion 110 and a top portion 120, as well as a physical randomizing component 130. The base portion 110 can include a visual display 112, which can include a touchscreen and/or other player input and output capabilities. One or more player or user inputs, such as buttons 114, 115, can be used for a variety of player input functions, such as to facilitate activation of the physical randomizing component 130. A bill acceptor 116, ticket acceptor or other device adapted to accept and provide player credit may also be provided on base portion 110. Other items not shown may also be included, as will be readily appreciated, with such items including, for example, a player card reader, player tracking device, camera, added displays, added inputs, speakers, seats, and the like.

Top portion 120 can include a top visual display 122, which may or may not be game or theme related. One or more additional items may also be included on top portion 120, such as a top glass, bezel, speaker, candle light, added displays, further input or output components, or the like. Also, various items that might be located on base or bottom portion 110 may instead be included on top portion 120, as may be desired.

The physical randomizing component 130 can include an encapsulation bubble 132 or other similar component, such that one or more physical game objects 134 inside are visible to the player or user. Encapsulation unit 132 can be formed from glass, plastic, or other suitable material that permits the ready view of physical game objects 134. These physical game objects (or physical objects) can be any such game objects or objects as might be found on a live gaming table, including for example, dice, cards, balls, wheels, and the like, which may be presented alone or in any combination. As shown, three dice are presented as the exemplary physical game objects 134 for the exemplary eMachine 100 illustrated. Such physical objects 134 can be used to provide a substantially random outcome that forms a full actual game result or at least a part of an actual game result for a player at eMachine 100.

For purposes of clarity and to distinguish one from the other, this description shall refer generally to player input for the physical randomizing component 130 as “activation” and the physical shaking or moving of the dice or other physical game objects as “actuation,” although other terms can also or alternatively be used for such events. In some embodiments, an activation and actuation can be accomplished at the same time, such as by way of a physical pinball or pachinko ball plunger or lever that is activated and actuated by the player. In other embodiments, a player activation can be converted from analog to digital within the device or system, which input can then be converted back from digital to analog at an actuation stage onto the actual physical game objects. For example, a player activation of a button can be measured in one or more ways, which inputs are then digitized and used to effect the level and/or way of actuation of the physical game objects or components.

An actuation device or component (not shown here) can be used to physically shake or otherwise redistribute the physical components, which are dice in the illustrated example. Although dice are shown as the physical game objects, it will be readily appreciated that other physical game objects could be used as well. Such an actuation device or component can be, for example, a movable floor under the dice within physical randomizing component 130. Such a movable floor or other suitable actuation device can present a sudden shaking force, vibration, or the like, which causes the dice to shake, jumble, or otherwise redistribute for a different outcome across their tops. The actuation of such a component can be caused at least in part by the player or user, such as by an activation event like pressing button 114 and/or 115. In various embodiments, the actual actuation of the dice or other physical components 134 does not take place until the player or user actually provides a physical input at the eMachine.

Variations in the activation input provided by the player can be used by the eMachine 100 to vary the actuation of the physical components 134. For example, variations in the physical activation from the single user can result in weaker or stronger actuation of said one or more physical objects. That is, a hard push or pounding of button 114 might result in stronger shaking of the dice 134, while a soft push of the button might result in a gentle shake of the dice. As another example, the alternative use of button 115 might result in a swirling or spinning effect to the dice 134 that is different than the shaking effect activated by button 114. Alternatively, or in addition, the use of both buttons 114 and 115 might result in added effects to the actuation of the dice 115. Also, or in addition, the timing of the button or button presses might affect the timing of one or more physical activations that provide a new dice outcome. Such timings may effect when the physical actuation starts, when it stops, and/or its duration, for example. Such timings might also coincide with other visual or audio outcomes or cues provided by the eMachine, such as on video display 112 or elsewhere.

Other types of player activation components could also be used, with similar and/or additional effects to the physical game components. Such other player activation components could include, for example, plungers, touchscreens adapted to accept various touches, swipes or the like, wheels, reels, motion or gesture reading sensors, voice recognition devices, and the like. For example, a motion sensor might be adapted to help the device or system recognize a hard shake player activation based upon a rapid shaking motion or gesture by a player, and/or to recognize a soft shake player activation based upon a gentle or slow motion or gesture by the player. Alternatively, and/or in addition, a microphone and voice recognition device might be adapted to help the device or system recognize various voice commands, as well as volume levels.

In this way, the manner of actual physical activation by the player of the dice or other physical objects 134 results in variations or differences in how the dice or other objects are actually shaken or jumbled, which then affects the actual game outcome. Thus, the player or user actually does have a tangible impact on the result of the game, similar to a craps player having a tangible impact on the game outcome based on how he or she throws the actual physical dice. Similar results can be had with respect to card games, for example, by allowing players leeway in how or where a newly shuffled deck is cut within a similar physical randomizing component. In other embodiments, a physical plunger similar to a pinball game plunger can be used to shoot or eject a ball for an actual roulette game, pachinko game, or other similar game involving one or more physical balls. Players can thus feel that they have some legitimate impact on the result of their games played on eMachine 100.

In various embodiments, the base portion 110 can be removable from and interchangeable with top portion or “top box” 120 and other similar top portions, and vice versa. Similarly, top portion 120 can be removable from and interchangeable with bottom portion 110 and other similar bottom portions. Under any such arrangement, physical randomizing component 130 may also comprise a separate item that goes with or is removable from and/or interchangeable with bottom portion 110, top portion 120, or both. In some embodiments, the physical randomizing component 130 can be modular from the remainder of eMachine 100, such that different physical randomizing components can be swapped in and out of the eMachine as may be desired.

In various embodiments, one or more cameras (not shown), sensors, or other detection devices can be used to detect the actual outcomes on the one or more physical components 134. Sensors could include, for example, cameras, RFID readers, magnetic readers or detectors, barcode readers or the like, pressure sensors, motion detectors, among other possible sensors. Such a camera, cameras, and/or other sensors can be located about the top box 120, at or within the physical randomizing component 130, and/or at other locations at or along the eMachine 100, as may be appropriate. In some embodiments, these cameras and/or other sensors can remain with the base eMachine unit while a given physical randomizing component 130 is interchanged or swapped out for another one. Replaceable sensor components and/or other randomizing component items can add to the varieties of user selection and preferences for eMachine 100.

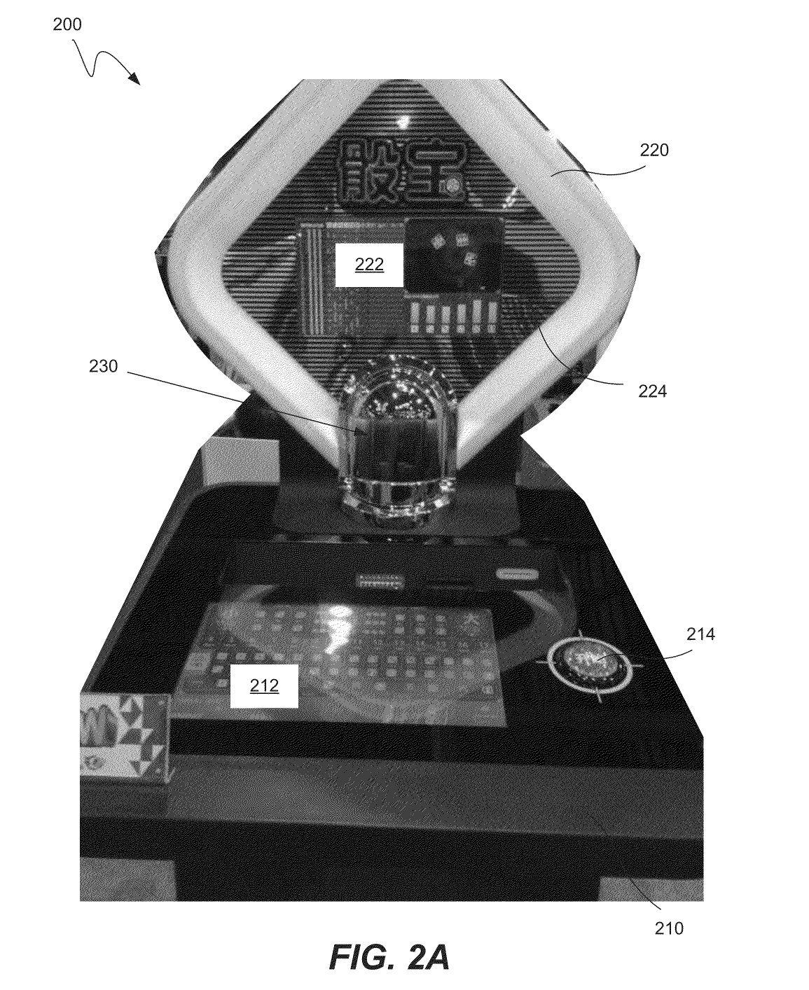

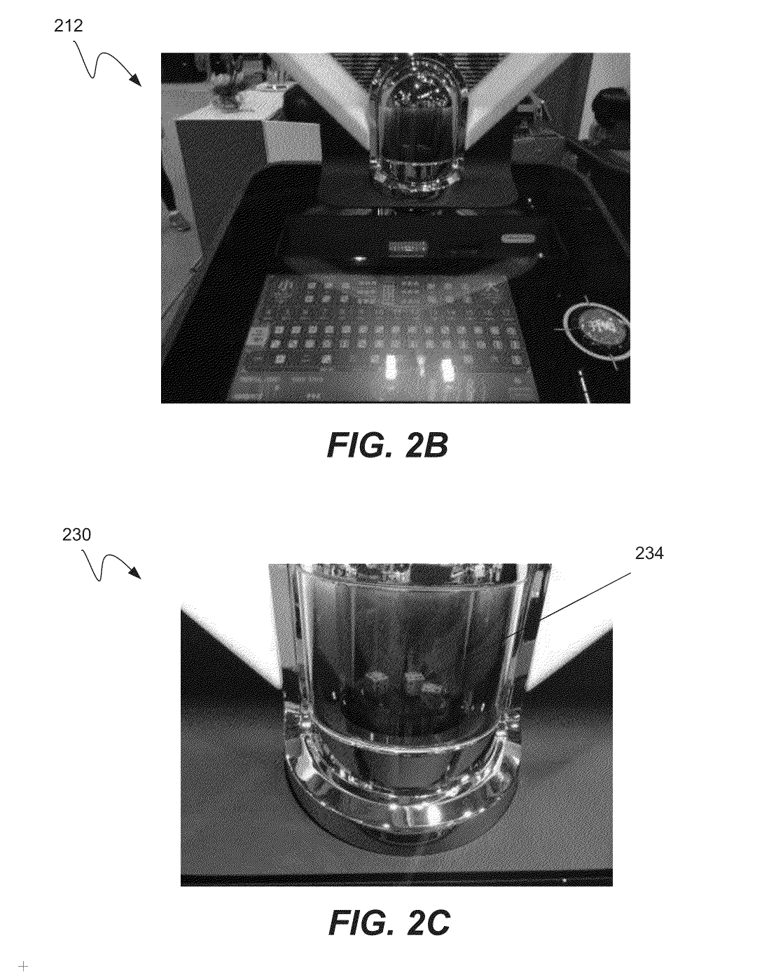

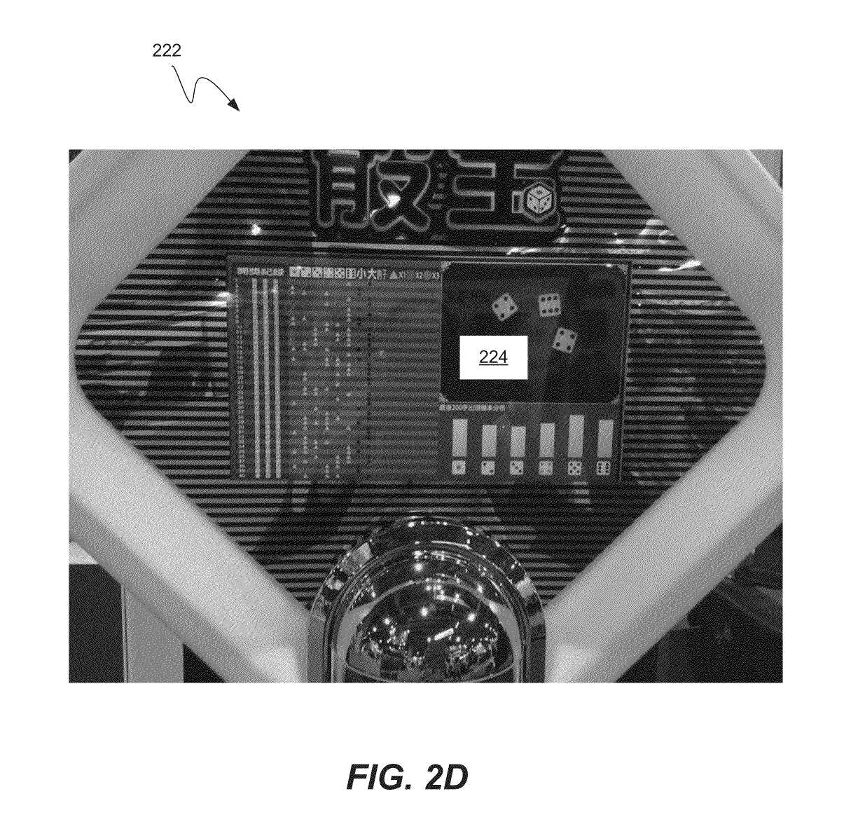

Moving next to FIG. 2A, an alternative exemplary individualized interactive table gaming machine according to one embodiment of the present disclosure is shown in front elevation view. Personalized or individualized interactive table gaming machine 200 can be substantially similar to eMachine 100 above. As such, eMachine 200 can include a bottom portion or base 210, a top portion or top box 220, and a physical randomizing component 230. Again, the bottom or base portion 210 can include a video display 212, which can include a touchscreen, as well as one or more player activation inputs, such as button 214, among other electronic gaming machine components. Similarly, top box 220 can include an outer bezel and an upper display 222, which can include a visual display 224 of the physical game components from physical randomizing component 230. Such a visual display 224 can be an actual live feed, a picture freeze, or a digital recreation of the dice or other physical game components. As shown, a digital recreation can not only provide a graphical representation of the dice (or other physical component) outcome, but can also show recent historical results, statistics, and other interesting information with respect to the eMachine 200.

FIGS. 2B-2D illustrate in front elevation close up views various portions of the alternative exemplary individualized interactive table gaming machine of FIG. 2A according to one embodiment of the present disclosure. FIG. 2B depicts the full lower box video and touchscreen presentation 212, while FIG. 2C depicts a close up of the physical randomizing component 230, which includes three dice 234 in this instance. Also, FIG. 2D shows an upper display 222, which includes at least a portion 224 that is dedicated to the visual display of the physical dice within component 230.

Again, while the embodiments provided herein have been made with respect to a dice game, such as sicbo or craps, it will be readily appreciated that numerous other table type games can also be provided in association with eMachine 100. Such other games can include, for example, a lotto or lottery type game involving physical ping pong balls or other similar items, a fortune wheel or other similar game involving a rotating wheel, one or more large rotating balls, wheels, reels, or other items. Various games involving multiple balls that can be in play at the same time might also be used, such as pachinko, pinball, pachisuro, and the like, a coin flipping game, a rotating dice game, and/or a player controlled slot reel type of game, whereby the player or user has significant control over the slot reel speed, starting, and/or stopping.

In various embodiments, one or more eMachines can contain a number of different possible games with the same or different physical game objects. Such eMachines can then offer players a choice of different games. Such games may involve different physical game objects within one or more physical randomizing components, for example. eMachines having multiple physical randomizing components can include a manual or automated process where different randomizing components having different physical game objects contained therein can be swapped out or activated depending upon the game selected.

In some embodiments, the same physical game objects can be used although the selected game may vary. For example, the illustrated eMachine 200 can be configured for sicbo, but can also be configured for craps, such as where only two dice are rolled or randomized, rather than three. A player selection between sicbo and craps could then involve one die being taken out of or being put back into play. Other types of dice games or other variations whereby games with the same or similar physical game objects can also be configured for play by an eMachine in a similar manner.

In some embodiments, a player may also be offered an option to choose between different physical game objects. For example, a live table game of craps will often offer a player a choice of two dice from between many more possible dice in order to roll or “shoot.” Similarly, eMachine 200 may offer a player the ability to choose three dice from a larger set of dice in order to play a game of sicbo, or to choose two dice from a larger set in order to play craps. The larger set of dice could be 4 or more dice, such as, for example, a dozen different dice, which are all contained within the eMachine 200. In such embodiments, the dozen different dice, for example, could be contained within a given physical randomizing component 230. A player could then select three dice from the total dozen provided (or two for craps, or any other number per the relevant dice game being played), whereupon the remaining unselected dice are then set aside and not used for the play of the game. Again, such offerings and choices can provide players with the feeling that they are helping to control or otherwise affect the outcomes of the actual games played, which is a feature that can be very attractive to some players.

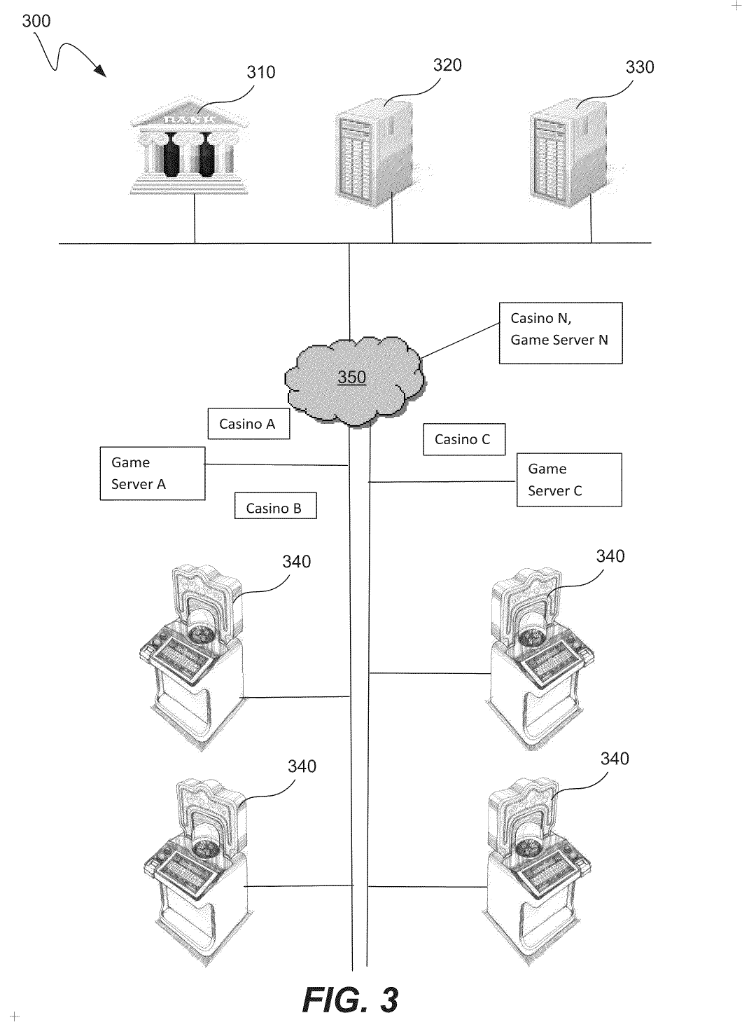

Transitioning next to FIG. 3, an exemplary wide area interactive table gaming machine system utilizing multiple gaming machines, a remote system server, and various other system components across multiple locations is illustrated in block diagram format. Wide area system 300 can include a wide variety of components and items, such as a bank 310, a games router 320, and a financial clearinghouse 330, among other items. A cloud 350 or network can couple these items to various eMachines 340, terminals, game servers, casinos, and other distributed components, as may be desired. Various networked casinos, game servers, eMachines 340 and other remote terminals can also be coupled through the cloud 350 or network in wide area system 300. Such a gaming system or network can be of wired (Ethernet, Token Ring, Serial multidrop, ATM, etc.) or wireless variety (802.11x, BlueTooth, LTE, 2G/3G/4G cellular, Zigbee, Ultra Wide Band, etc.) known in the art, as may be suitable or desired.

One or more game servers may be present in wide area system 300, and each may operate in a particular manner to facilitate the play of the various networked eMachines set forth above. In such embodiments, a game server can collect live game information from each self-contained eMachine 340, apply game rules, and return game results. Besides monitoring and controlling the games, the game server can also keep track, in a database, the game history of each eMachine and its associated physical components, accounting information, revenue reports, bonuses and bonusing progress, mystery jackpots, maintenance information, and the like. Each of these individual functions can be performed by a separate application on a separate server, or integrated into one application running on one comprehensive server. The determination of one or multiple servers and applications depends on the number of eMachines, game stations, casinos, and other associated devices, both local and remote, that are being connected across the system. For example, a specialized system server or processor can be dedicated to tracking playing card IDs and locations.

Further functions of the system servers can include game resolution at various eMachines, the handling of financial transactions from eMachines and/or remote game terminals, the push of live game information to the game server to be broadcast to other eMachines and other remote gaming terminals, matchmaking between various system devices and stations, providing communications between system components, and other pertinent gaming system functions. Details regarding these and other gaming system functions can be found at, for example, U.S. patent application Ser. Nos. 14/017,073; 14/017,071; 13/948,101; 13/893,340; and 13/844,617, each of which are incorporated by reference herein for such purposes, among other locations.

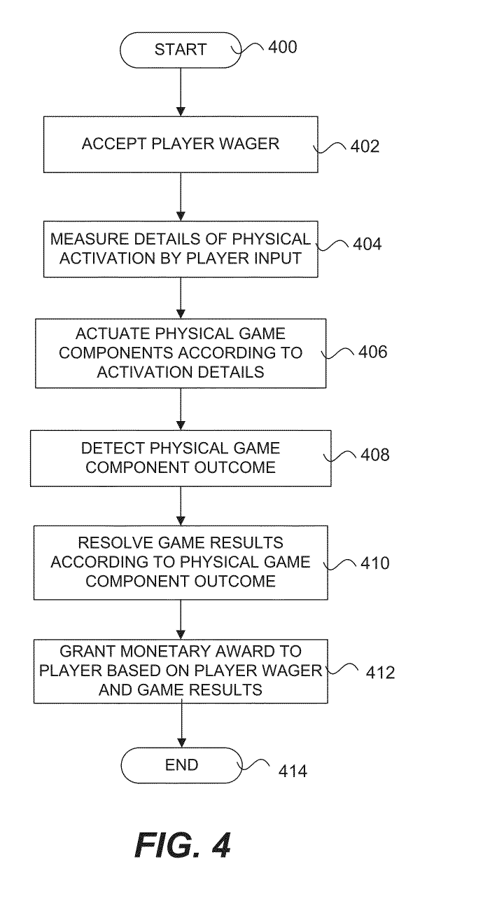

Moving lastly to FIG. 4, a flowchart of an exemplary method of administering a wager based game on an individualized or personalized table gaming machine is provided. After a start step 400, a suitable player wager is accepted at a process step 402. At a following process step 404, details with respect to a physical activation by way of player input are measured. Again, such details can involve the force by which a player presses a button or pulls a plunger, as well as the timing thereof. Other possible player activation inputs can involve swiping a touchscreen, a wave or gesture, and/or a voice activation, among other possibilities. In addition, the use or lack of use of multiple optional player inputs may also be measured and used.

At a process step 406, the physical game components are actuated according to the measured activation details. In some embodiments, this can involve an analog to digital conversion at the player activation input, and then a digital to analog conversion at the actuation of the physical game components. In other embodiments, the actual player input can physically affect the actual physical game components in either a direct or indirect manner without such conversions, such as by way of a pinball or pachinko plunger or lever. At the next process step 408, the physical outcomes of the physical game components are detected, after which the game results are resolved according to the physical outcomes at process step 410. A monetary award based on the player wager and game results can then be granted in at least some instances at process step 412. The method then ends at end step 414.

For the foregoing flowchart, it will be readily appreciated that not every method step provided is always necessary, and that further steps not set forth herein may also be included. For example, added steps can involve measuring multiple player inputs, swapping out physical game components or modules, aggregating external results, logging and presenting game histories or stats, resolving player wagers at other devices based upon the physical game component at a given device, evaluating factors or outcomes for bonus progressions or status, and facilitating system tournament play, among other possible steps. Furthermore, the exact order of steps may be altered as desired, and some steps may be performed simultaneously. For example, step 606 may be performed before or after step 604 in various embodiments. In addition, while the provided examples are with respect to dice games, it will be readily understood that other casino and wagering games can be similarly adapted to provide similar items used for other physical table type games. Such items can include, for example, wheels, reels, balls, cards, tiles, chips, tokens, and the like.

Those skilled in the art will readily appreciate that any of the systems and methods of the disclosure may include various computer and network related software and hardware, such as programs, operating systems, memory storage devices, data input/output devices, data processors, servers with links to data communication systems, wireless or otherwise, and data transceiving terminals, and may be a standalone device or incorporated in another platform, such as an existing electronic gaming machine, portable computing device or electronic platforms with multiple player positions. In addition, the system of the disclosure may be provided at least in part on a personal computing device, such as home computer, laptop or mobile computing device through an online communication connection or connection with the Internet. Those skilled in the art will further appreciate that the precise types of software and hardware used are not vital to the full implementation of the methods of the disclosure so long as players and operators thereof are provided with useful access thereto or the opportunity to play the game as described herein.

The various aspects, embodiments, implementations or features of the described embodiments can be used separately or in any combination. Various aspects of the described embodiments can be implemented by software, hardware or a combination of hardware and software. Computer readable medium can be any data storage device that can store data which can thereafter be read by a computer system. Examples of computer readable medium include read-only memory, random-access memory, flash drives, USB drives, CD-ROMs, DVDs, magnetic disk drives, magnetic tape, optical data storage devices, and carrier waves. The computer readable medium can also be distributed over network-coupled computer systems so that the computer readable code is stored and executed in a distributed fashion.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. An individualized interactive table gaming machine, comprising:
one or more input components adapted to accept a physical activation from a single user regarding the play by the single user of wager based games that involve the placement of wagers by the single user, the play of games by the single user based upon the wagers, and the grant of monetary awards to the single user based upon game results;
a processor coupled to the one or more input components, said processor being adapted to accept input therefrom and utilize the input to facilitate the play of the wager based games;
one or more display components coupled to the processor, said one or more display components being adapted to display to the single user information regarding the wager based games played by the single user; and
a physical randomizing component coupled to the processor, said physical randomizing component including one or more physical game objects from table type games that provide substantially random outcomes when actuated by the processor, wherein the substantially random outcomes of the one or more physical game objects form at least a part of the game results, wherein actuation by the processor results from the physical activation from the single user, and wherein variations in the physical activation from the single user affect variations to the substantially random outcomes of the one or more physical game objects.

2. The individualized interactive table gaming machine of claim 1, wherein neither said processor nor any other associated processing component provides an electronic random number generated output.

3. The individualized interactive table gaming machine of claim 1, wherein said game results are based completely upon the substantially random outcomes of the one or more physical game objects.

4. The individualized interactive table gaming machine of claim 1, wherein at least one of said one or more physical game objects is selected from the group consisting of one or more physical dice, one or more physical playing cards, one or more balls, and one or more physical wheels.

5. The individualized interactive table gaming machine of claim 1, wherein said variations in the physical activation from the single user result in weaker or stronger actuation of said one or more physical game objects.

6. The individualized interactive table gaming machine of claim 1, wherein said variations in the physical activation from the single user include the timing of the physical activation.

7. The individualized interactive table gaming machine of claim 1, wherein said one or more physical game objects used to form at least a part of game results are selected by the player from a larger set of potential physical game objects.

8. The individualized interactive table gaming machine of claim 1, further including:
one or more sensor components adapted to detect the substantially random outcomes of the one or more physical game objects.

9. The individualized interactive table gaming machine of claim 8, wherein said one or more sensor components are coupled to said processor and adapted to communicate the detected physical game object outcomes to the processor, and wherein said processor is further adapted to use the communicated physical game object outcomes to process the game results for the user.

10. The individualized interactive table gaming machine of claim 1, wherein said gaming machine is fully self-contained and thereby adapted to facilitate the processing of all game aspects without any need for further input from any other system components or any manual operator intervention.

11. The individualized interactive table gaming machine of claim 1, wherein the substantially random outcomes of the one or more physical game objects provide results for a bonus game outcome.

12. The individualized interactive table gaming machine of claim 1, further including:
a network interface coupled to said processor and adapted to couple the gaming machine to one or more outside networked devices, said one or more outside networked devices including one or more substantially similar gaming machines, a network server, or both.

13. The individualized interactive table gaming machine of claim 12, wherein said gaming machine further provides the user with the ability to wager on substantially random outcomes of one or more physical objects located at another networked substantially similar gaming machine.

14. The individualized interactive table gaming machine of claim 13, wherein said gaming machine further provides the user with the ability to search past results from substantially random outcomes of one or more physical objects located at one or more other networked substantially similar gaming machines.

15. The individualized interactive table gaming machine of claim 12, wherein said gaming machine further provides the user with the ability to participate in a tournament based upon substantially random outcomes of one or more physical objects located at one or more other networked substantially similar gaming machines.

16. An interactive table gaming machine system, comprising:
a plurality of self-contained individualized interactive table gaming machines, each of said gaming machines including:
one or more input components adapted to accept a physical activation from a single user regarding the play by the single user of wager based games that involve the placement of wagers by the single user, the play of games by the single user based upon the wagers, and the grant of monetary awards to the single user based upon game results,
a dedicated processor separate from all other dedicated processors and coupled to the one or more input components, said dedicated processor being adapted to accept input therefrom and utilize the input to facilitate the play of the wager based games,
one or more display components coupled to the dedicated processor, said one or more display components being adapted to display to the single user information regarding the wager based games played by the single user,
a dedicated physical randomizing component coupled to the dedicated processor, said dedicated physical randomizing component being separate and independently operable from all other dedicated physical randomizing components and including one or more physical objects from table type games that provide substantially random outcomes when actuated by the dedicated processor, wherein the substantially random outcomes of the one or more physical objects form at least a part of the game results, wherein actuation by the dedicated processor results from the physical activation from the single user, and wherein variations in the physical activation from the single user affect variations to the substantially random outcomes of the one or more physical objects, and
a network interface adapted to couple the gaming machine to one or more system devices including one or more others from the plurality of self-contained individualized interactive table gaming machines, a network server, or both; and
a network server coupled to one or more of the plurality of self-contained individualized interactive table gaming machines, said network server being adapted to facilitate interactivity between the plurality of self-contained individualized interactive table gaming machines.

18. The interactive table gaming machine system of claim 16, wherein said system provides a user thereof with the ability to wager on substantially random outcomes of one or more physical objects located at one or more of the self-contained individualized interactive table gaming machines that are separate from the one being used by the user.

19. The interactive table gaming machine system of claim 16, wherein said system provides a user thereof with the ability to search past results from substantially random outcomes of one or more physical objects located at one or more of the self-contained individualized interactive table gaming machines that are separate from the one being used by the user.

20. The interactive table gaming machine system of claim 16, wherein said system provides a user thereof with the ability to participate in a tournament based upon substantially random outcomes of one or more physical objects located at one or more of the self-contained individualized interactive table gaming machines that are separate from the one being used by the user.
